(19) United States
(12) Patent Application Publication
(10) Pub. No.: US 2013/0072314 A1
(43) Pub. Date: Mar. 21, 2013

(54) Printable Playhouse

(71) Applicants: William Louis Goodman, Cumberland Foreside, ME (US); Gunnar Alldritt Hubbard, Falmouth, ME (US); Colin Walter Schless, Portland, ME (US)

(72) Inventors: William Louis Goodman, Cumberland Foreside, ME (US); Gunnar Alldritt Hubbard, Falmouth, ME (US); Colin Walter Schless, Portland, ME (US)

(73) Assignee: BILL GOODMAN CONSULTING, LLC, Portland, ME (US)

(21) Appl. No.: 13/619,170

(22) Filed: Sep. 14, 2012

Related U.S. Application Data
(60) Provisional application No. 61/535,046, filed on Sep. 15, 2011.

(51) Int. Cl. A63G 31/00; B23P 17/04

(52) U.S. Cl. 472/136; 29/428

(57) ABSTRACT

A three dimensional structure, including but not limited to a playhouse for children, includes at least three interlocking panels that are configured so as to interlock one with at least one other without the use of hand tools. The at least three interlocking panels have an interior surface and an exterior surface, where at least one of the interior surface and the exterior surface of one or more of the at least three interlocking panels has a first printed pattern applied thereon. Also disclosed are methods of manufacturing and selling the three dimensional structure.

### RELATED APPLICATIONS

This application claims priority to provisional U.S. Patent Application No. 61/535,046 filed Sep. 15, 2011, entitled “Printable Playhouse,” which is incorporated herein by reference in its entirety.

### TECHNICAL FIELD

Embodiments relate generally to three dimensional structures, such as playhouses for children, and methods of manufacturing and selling the same.

### BACKGROUND

Playhouses for children are typically miniaturized houses sized for children to play in. As such, the assembly or construction of such playhouses (i.e., miniature houses) is the same or similar to that for standard houses, except perhaps that the designs for these playhouses are generally simplified. In other words, the assembly or construction typically involves intensive labor—involving two or more people, and sometimes requiring the services of hired workmen—and the use of various tools, including, for example, hammers, nails, screwdrivers, screws, and drill sets.

Because these playhouses are essentially miniaturized houses, such playhouses typically do not take into account the imaginations and creative expressions of children, and thus do not provide an outlet for such creative expressions.

Further, because these playhouses require intensive labor to assemble or construct, and because they are sized for children, it is difficult for adults to change the interiors of these playhouses to maintain them over time or to update them to suit the changing needs of the children as the children grow older.

The embodiments disclosed herein are directed toward overcoming one or more of the problems discussed above.

### SUMMARY OF THE EMBODIMENTS

Various embodiments of the three dimensional structure are intended and designed to be assembled without the use of tools (such as hammers, nails, screwdrivers, screws, drill sets, etc.).

Various embodiments are also intended and designed to include interior and/or exterior surfaces that are printed with a first set of patterns and designs selected by the customer (e.g., for playhouses, the children who would play in the three dimensional structure would be given the opportunity to aid their parents in the selection of the patterns and designs for the interior and/or exterior surfaces of the playhouse). In some embodiments, chalkboard surfaces (e.g., chalkboard windows and doors) are provided in the playhouses, so that children may draw on these surfaces as an outlet for their imagination and creative expressions.

Because the three dimensional structure as described in relation to various embodiments is easy to assemble and disassemble without the use of tools, various embodiments allow for the disassembly and return of panels of the embodiment to a printing facility to repaint the surfaces in preparation for reprinting the interior and/or exterior panels with a second set of patterns and designs. The first and second sets of patterns and designs could be the same, whereby reprinting would be, e.g., for maintenance purposes over time. The first and second sets of patterns and designs could be different, whereby reprinting would be, e.g., for updating the look of the three dimensional structure (e.g., for the playhouse, the children could have changed their preferences as they grow older, so that, e.g., the children who once preferred to play in a fantasy playhouse now want to play in a modern, life-like playhouse). While reprinting could be by returning the panels, other alternatives include ordering from the supplier replacement panels, adhesive stickers printed with new images to cover existing panels or sheets (made of vinyl or suitable materials) printed with images that can be placed over select panels or surfaces such as walls or floors.

Various embodiments of the three dimensional structure include at least three interlocking panels, wherein the at least three interlocking panels are configured so as to interlock one with at least one other without the use of hand tools. In some embodiments, the at least three interlocking panels have an interior surface and an exterior surface, wherein at least one of the interior surface and the exterior surface of one or more of the at least three interlocking panels has a first printed pattern applied thereon. In some embodiments, the three dimensional structure includes at least four interlocking wall panels, at least one floor panel, and at least one roof panel, wherein the at least one roof panel and/or the at least one floor panel is configured so as to interlock with one or more of the at least four interlocking wall panels, without the use of hand tools.

In some embodiments, each of two or more of the at least four interlocking wall panels, the at least one roof panel, and the at least one floor panel includes at least one slot therein, wherein each of said at least one slot is configured to interlock with another of said at least one slot so as to connect, in a tool-free manner, two of the at least four interlocking wall panels, the at least one roof panel, and the at least one floor panel. In some embodiments, the three dimensional structure includes at least one support module on which one or more of the at least one floor panel and the at least four interlocking wall panels rests on a surface of the ground.

In some embodiments, the three dimensional structure includes a plurality of connectors, wherein the at least four interlocking wall panels are configured to connect with each other and with the at least one roof panel via use of the plurality of connectors, and wherein the plurality of connectors are configured to connect the at least four interlocking wall panels and the at least one roof panel to each other without use of hand tools. In some embodiments, one or more of the at least four interlocking wall panels comprises at least one door panel and at least one window panel, wherein one or more of the at least one door panel and the at least one window panel each includes a chalk board surface thereon, said chalk board surface being configured so as to allow chalk writings or drawings to be made thereon. In some embodiments, one or more of the at least one window panel is made of a material selected from a group consisting of transparent plastic, at least partially opaque plastic, glass, wood, paper, and chalk board.

In some embodiments, some of the at least four interlocking wall panels, at least one floor panel, and at least one roof panel are configured to receive a printed pattern on at least one of an interior and an exterior surface of each panel. The printed patterns are selectable from at least one of a plurality of pre-designed patterns and at least one custom design pattern, wherein the at least one custom design pattern is designed by a customer or designed on behalf of the customer. In some embodiments, the at least one of the plurality of pre-designed patterns and at least one custom design pattern are selectable from a group consisting of bright color patterns, dark color patterns, multicolor patterns, character patterns, nature patterns, abstract patterns, and any combination thereof, wherein the character patterns include patterns resembling animals, patterns resembling humans, patterns resembling man-made structures, and patterns resembling fictional animal, human, or non-terrestrial characters, wherein the nature patterns include patterns resembling plant life, patterns resembling nature scenes, and patterns resembling fictional terrestrial or non-terrestrial landscapes.

In some embodiments, the at least four interlocking wall panels are of different dimensions, such as to form a three dimensional structure of irregular shape, when the at least four interlocking wall panels are assembled together with the at least one roof panel. In some embodiments, the at least four interlocking wall panels and the at least one roof panel, when assembled together, are configured such that the at least four interlocking wall panels form two or more rooms in the three dimensional structure. In some embodiments, one or more of the at least four interlocking wall panels is configured to be flat, curved, or a combination thereof.

According to various embodiments, a method of manufacturing the three dimensional structure includes: (a) forming at least three interlocking panels, wherein each of the at least three interlocking panels includes a first surface and a second surface, wherein the first surface is designated to be an interior surface when the three dimensional structure is assembled, and wherein the second surface is designated to be an exterior surface when the three dimensional structure is assembled; (b) tooling one or more of the at least three interlocking panels so as to make one interlockable with at least one other in a tool-free manner; and (c) applying a printed pattern on at least one surface of one or more of the at least three interlocking panels. In some embodiments, the method further includes forming four wall panels, at least one floor panel, and at least one roof panel, wherein the at least one roof panel is configured so as to interlock with one or more of the at least four interlocking wall panels, without the use of hand tools.

In some embodiments, forming the at least four wall panels, the at least one roof panel, and the at least one floor panel includes forming the panels by cutting from one or more pieces of material, wherein the one or more pieces of material are selected from a group consisting of planks of wood, planks of plywood, sheet metal, plastic sheets and combinations thereof. Alternatively, forming the at least four wall panels, the at least one roof panel, and the at least one floor panel may include forming each panel by a molding process.

According to some embodiments, tooling the one or more of the at least four wall panels and the at least one roof panel includes forming at least one slot in each of two or more of the at least four interlocking wall panels, the at least one roof panel, and the at least one floor panel. In some embodiments, tooling the one or more of the at least four wall panels and the at least one roof panel includes forming a plurality of connecting points in each of two or more of the at least four interlocking wall panels, the at least one roof panel, and the at least one floor panel, wherein the plurality of connecting points are configured to connect with a plurality of connectors that allow the at least four interlocking wall panels to connect in a tool-free manner with each other and with the at least one roof panel.

In some embodiments, the method includes forming at least one recess in one or more of the at least four wall panels; forming at least one of a door panel and a window panel for each of the at least one recess; and tooling the at least one of the door panel and the window panel so as to make the at least one of the door panel and the window panel interlockable with said one or more of the at least four wall panels in a tool-free manner. According to some embodiments, the method includes conditioning one or more of the at least four wall panels, the at least one roof panel, and the at least one of the door panel and the window panel so as to create a curved surface therein.

In some embodiments, forming the at least one of the door panel and the window panel includes forming from a material selected from a group consisting of transparent plastic, at least partially opaque plastic, glass, wood, paper, and chalk board. In some embodiments, forming the at least four wall panels and the at least one roof panel includes forming the at least four wall panels having different dimensions, such as to form a three dimensional structure of irregular shape, when the at least four interlocking wall panels are assembled together with the at least one roof panel.

According to some embodiments, applying the printed pattern on at least one surface of one or more of the at least three interlocking panels includes receiving a design pattern from a customer, and applying the received design pattern on at least one surface of one or more of the at least three interlocking panels.

According to various embodiments, a method of selling a made-to-order three dimensional structure to a customer via a computer-based user interface includes: (a) providing the customer with the user interface for ordering a three dimensional structure, said three dimensional structure including at least three interlocking panels; (b) providing, within said user interface, first options to the customer for selecting a type of three dimensional structure for purchase, wherein the type of three dimensional structure includes single room, multi-room, simple, and fanciful; (c) providing, within said user interface, second options to the customer for selecting printable patterns for one or more of the at least three interlocking panels; and (d) placing an order with at least one third party manufacturer for making-to-order the at least three interlocking panels based on at least one of the first options and the second options that are selected by the customer.

In some embodiments, providing the customer with the user interface includes providing a web-based user interface accessible on a computer via the Internet. In some embodiments, providing the customer with the user interface includes providing a recording medium which includes software recorded thereon that, when executed by a computer, causes the computer to display the user interface that allows the customer to save options that the customer has selected on the computer, to determine whether the computer is connected to the Internet, and to send the saved options to a server via the Internet based on a determination that the computer is connected to the Internet.

In some embodiments, the method of selling includes providing, within said user interface, third options to the customer for selecting a shape for each room of the three dimensional structure to be ordered. In some embodiments, the method of selling includes providing, within said user interface, fourth options to the customer for selecting a number of doors and windows for the three dimensional structure; and providing, within said user interface, fifth options to the customer for selecting materials for the doors and windows, wherein said materials include transparent plastic, at least partially opaque plastic, glass, wood, paper, and chalk board. In some embodiments, the method of selling includes providing, within said user interface, sixth options to the customer for selecting a type of connecting devices, wherein the type of connecting devices include slots and connectors.

According to some embodiments, the printable patterns include a plurality of pre-designed patterns selectable from a group consisting of bright color patterns, dark color patterns, multicolor patterns, character patterns, nature patterns, abstract patterns, and any combination thereof, wherein the character patterns include patterns resembling animals, patterns resembling humans, patterns resembling man-made structures, and patterns resembling fictional animal, human, or non-terrestrial characters, wherein the nature patterns include patterns resembling plant life, patterns resembling nature scenes, and patterns resembling fictional terrestrial or non-terrestrial landscapes. In some embodiments, providing the second options for selecting printable patterns includes providing seventh options for the customer to upload custom design patterns, photographs, or other images to be printed on one or more of the at least four wall panels, the at least one roof panel, and the at least one floor panel. In some embodiments, the method of selling includes printing the printable patterns selected by the customer on one or more of the at least four wall panels, the at least one roof panel, and the at least one floor panel.

In some embodiments, the method of selling includes manufacturing components of the three dimensional structure in accordance with the customer's customized order. In some embodiments, the method of selling includes providing, within said user interface, eighth options for delivery of the three dimensional structure to the customer for assembly in a tool-free manner by the customer. In some embodiments, the method of selling includes shipping the three dimensional structure to the customer in accordance with the eighth options for delivery.

In some embodiments, computer software that is recorded on a recording medium, when executed by a computer, causes the computer to: (a) display a user interface that allows the customer to select first options for customizing and ordering a three dimensional structure; (b) receive first inputs corresponding to a selection of the first options from the customer via peripherals of the computer; (c) save the selected first options on the computer, in accordance with the received first inputs; (d) determine whether the computer is connected to the Internet; and (e) send the saved first options to a server via the Internet, based on a determination that the computer is connected to the Internet. In some embodiments, the computer software, when executed by the computer, further causes the computer to: (1) display, in the user interface, second options for the customer to purchase accessory components for the three dimensional structure; (2) receive second inputs corresponding to a selection of the second options from the customer via the peripherals of the computer; (3) save the selected second options on the computer, in accordance with the received second inputs; and (4) send the saved second options to the server via the Internet, based on the determination that the computer is connected to the Internet, wherein the accessory components include at least one of chalk doors, chalk windows, spare panels having design patterns printed thereon, lighting fixtures, furniture for the three dimensional structure, and flooring rugs or carpets.

In some embodiments, the method of assembling the three dimensional structure includes connecting the at least three interlocking panels, in a tool-free manner to form a 3-D structure, by utilizing the interlocking means. In some embodiments, the method of assembling includes connecting the at least one floor panel to the at least four interlocking wall panels in a tool-free manner, connecting each of the at least one door panel in the at least one first recess in a tool-free manner, and connecting each of the at least one window panel in the at least one second recess in a tool-free manner.

According to some embodiments, a three dimensional structure kit having component parts capable of being assembled includes the combination of at least three interlocking panels, each panel adapted to be interlocked, in a tool-free manner, with at least one other of the at least three interlocking panels.

According to some embodiments, the three dimensional structure is a playhouse for children to play in. In some embodiments, the three dimensional structure is a house for pets (e.g., a doghouse, a house for a cat, etc.). In some embodiments, the three dimensional structure is a toy dollhouse for children's dolls or action figures.

Various modifications and additions can be made to the exemplary embodiments discussed without departing from the scope of the invention. For example, while the embodiments described above refer to particular features, the scope of this invention also included embodiments having different combination of features and embodiments that do not include all of the above described features.

### BRIEF DESCRIPTION OF THE DRAWINGS

FIGS. 1 and 3 are front perspective views of embodiments of three dimensional structures 100.

FIGS. 2 and 4 are interior views of the three dimensional structures 100 as shown in FIGS. 1 and 3, respectively.

FIG. 5 is a top perspective view of an embodiment of the three dimensional structure 100.

FIG. 6A is a front elevation view of an embodiment of the three dimensional structure 100.

FIGS. 6B and 6C are illustrations of the patterns printed on a surface of the three dimensional structure 100 as shown in FIG. 6A.

FIG. 7A is a front perspective view of an embodiment of the three dimensional structure 100.

FIG. 7B is a side perspective view of the embodiment of the three dimensional structure 100 as shown in FIG. 7A.

FIG. 7C is a rear perspective view of the embodiment of the three dimensional structure 100 as shown in FIG. 7A.

FIG. 7D is a top perspective view of the embodiment of the three dimensional structure 100 as shown in FIGS. 7A-7C.

FIG. 7E is a bottom perspective view of the embodiment of the three dimensional structure 100 as shown in FIGS. 7A-7C.

FIG. 8A is an exploded view of the roof assembly, shown with a top, front perspective view of the embodiment of the three dimensional structure 100 as shown in FIG. 7A.

FIG. 8B is an exploded view of the roof assembly, shown with a top, rear perspective view of the embodiment of the three dimensional structure 100 as shown in FIG. 7A.

FIG. 8C is an exploded view of the floor assembly, shown with a bottom perspective view of the embodiment of the three dimensional structure 100 as shown in FIG. 7A.

FIG. 9 is a schematic diagram of plywood sheets with cut-outs of components that form the three dimensional structure 100 as shown in FIG. 7A.

FIGS. 10A-10I are enlarged schematic cut-out diagrams for each of the plywood sheets as shown in FIG. 9.

FIGS. 11A-11C are photographs of a three dimensional structure, which corresponds to the three dimensional structure as shown in FIG. 7A.

FIG. 12 is a front perspective view of an embodiment of the three dimensional structure 100, shown with furniture.

FIG. 13 is a flowchart illustrating representative method steps for selling a three dimensional structure 100 to a customer.

FIG. 14 is a flowchart illustrating representative method steps for manufacturing component parts and panels for the three dimensional structure 100.

### DETAILED DESCRIPTION

Unless otherwise indicated, all numbers expressing quantities of ingredients, dimensions reaction conditions and so forth used in the specification and claims are to be understood as being modified in all instances by the term “about.”

In this application and the claims, the use of the singular includes the plural unless specifically stated otherwise. In addition, use of “or” means “and/or” unless stated otherwise. Moreover, the use of the term “including,” as well as other forms, such as “includes” and “included,” is not limiting. Also, terms such as “element” or “component” encompass both elements and components comprising one unit and elements and components that comprise more than one unit unless specifically stated otherwise.

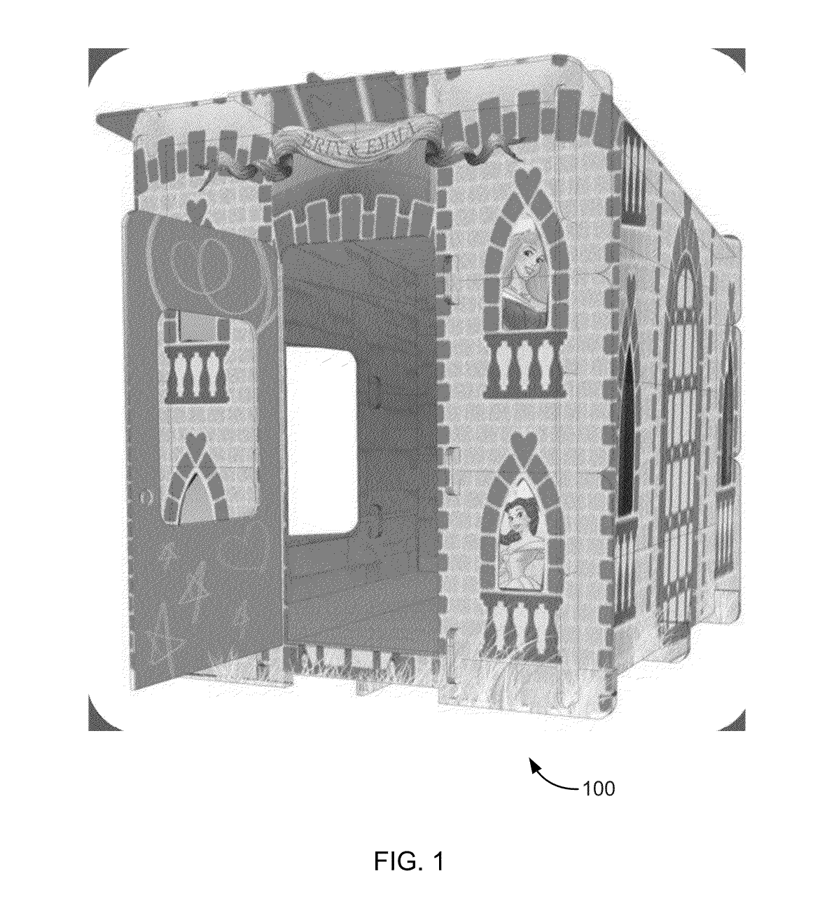

With reference to FIGS. 1-6, embodiments of the three dimensional structure 100 include a plurality of panels that interlock with one another in a tool-free manner, so as to form the three dimensional structure. As shown in FIGS. 1-4, both the interior and exterior surfaces of the panels may be printed with patterns. The patterns may be pre-designed patterns, customized patterns, or a combination of the two. The customized patterns may be designed by the customer. The patterns may be any of bright color patterns, dark color patterns, multicolor patterns, character patterns, nature patterns, abstract patterns, or any combination of these patterns. The character patterns may include patterns resembling animals, patterns resembling humans, patterns resembling man-made structures, and patterns resembling fictional animal, human, or non-terrestrial characters. The nature patterns may include patterns resembling plant life, patterns resembling nature scenes, and patterns resembling fictional terrestrial or non-terrestrial landscapes.

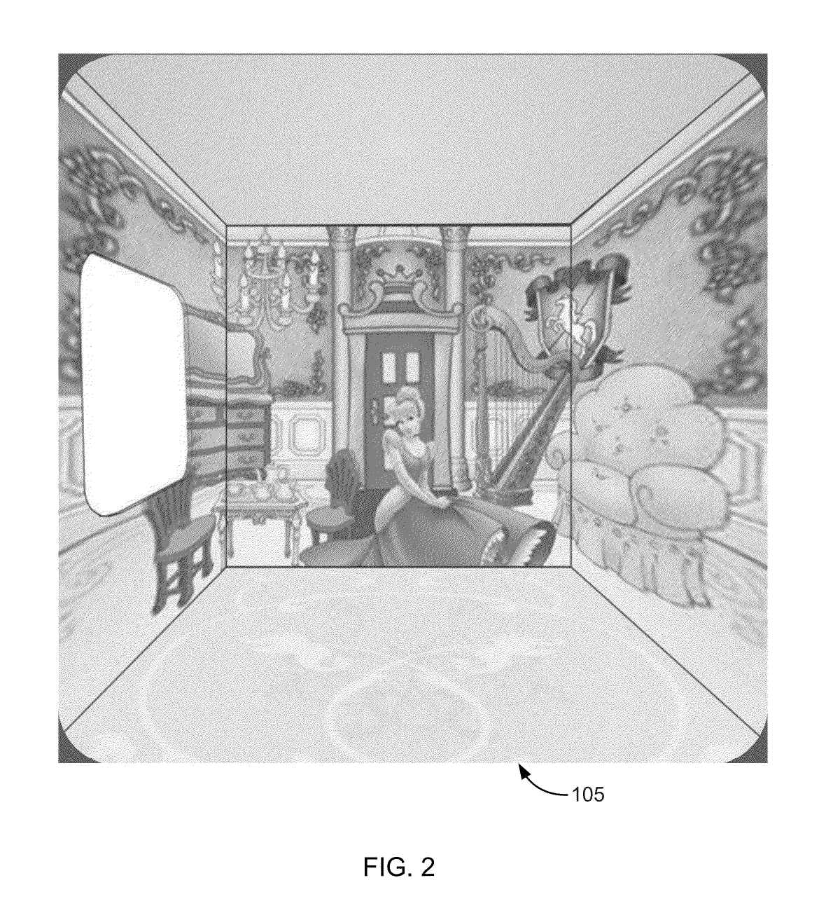

FIGS. 1 and 2 show an embodiment in which the exterior and interior surfaces, respectively, are printed with patterns of a fantasy princess theme. Because the printed patterns are easily customizable, the names of the children for whom the three dimensional structure 100 (in this case, a playhouse) is intended for play may be incorporated into the printed pattern—i.e., as shown above the front door in FIG. 1.

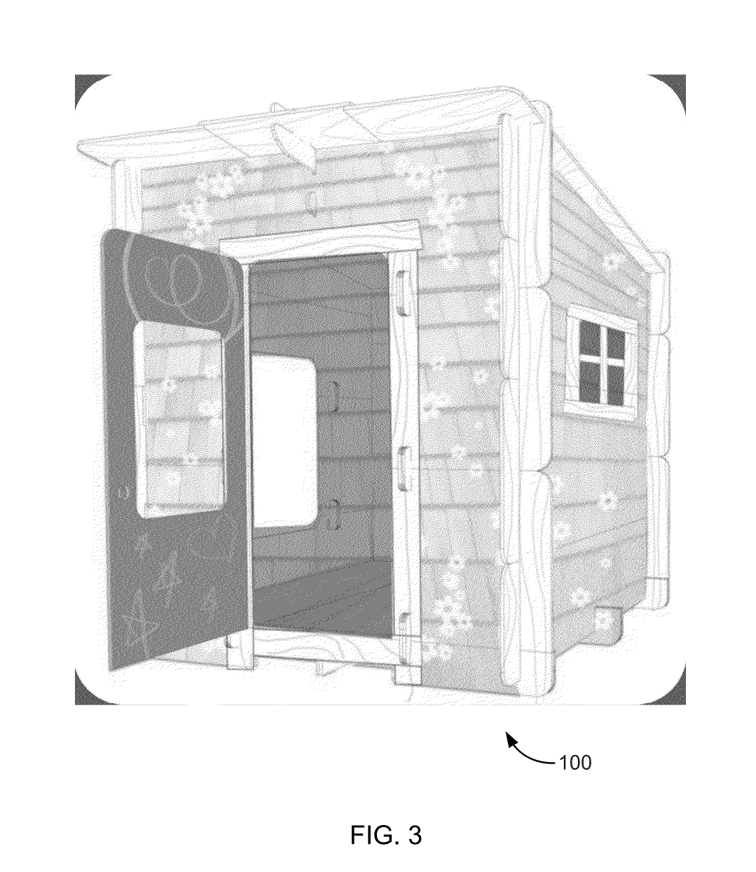

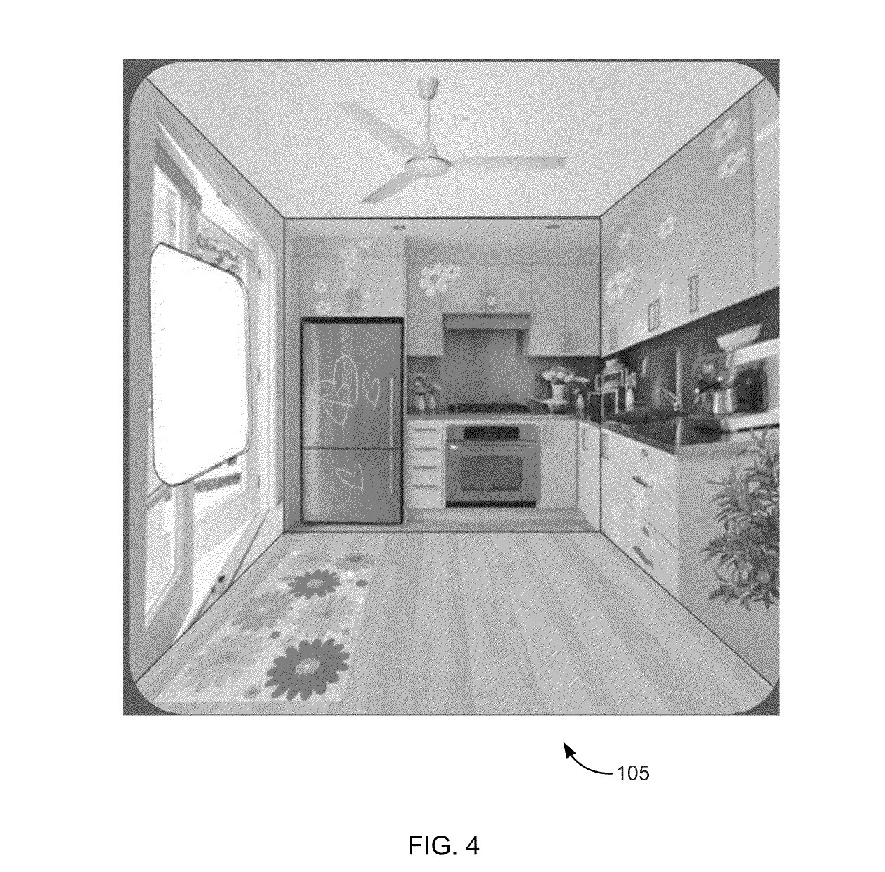

FIGS. 3 and 4 show an embodiment in which the exterior and interior surfaces, respectively, are printed with patterns of a modern house theme with a modern kitchen interior. FIGS. 2 and 4 show the respective floor and ceiling being printed with patterns corresponding to the themes of the fantasy princess playhouse or the modern kitchen playhouse. FIGS. 1 and 3 show the interior of the doors having a chalkboard surface on which children may draw, write, or otherwise express their imaginations or creativity. In some embodiments, window interiors would also have chalkboard surfaces.

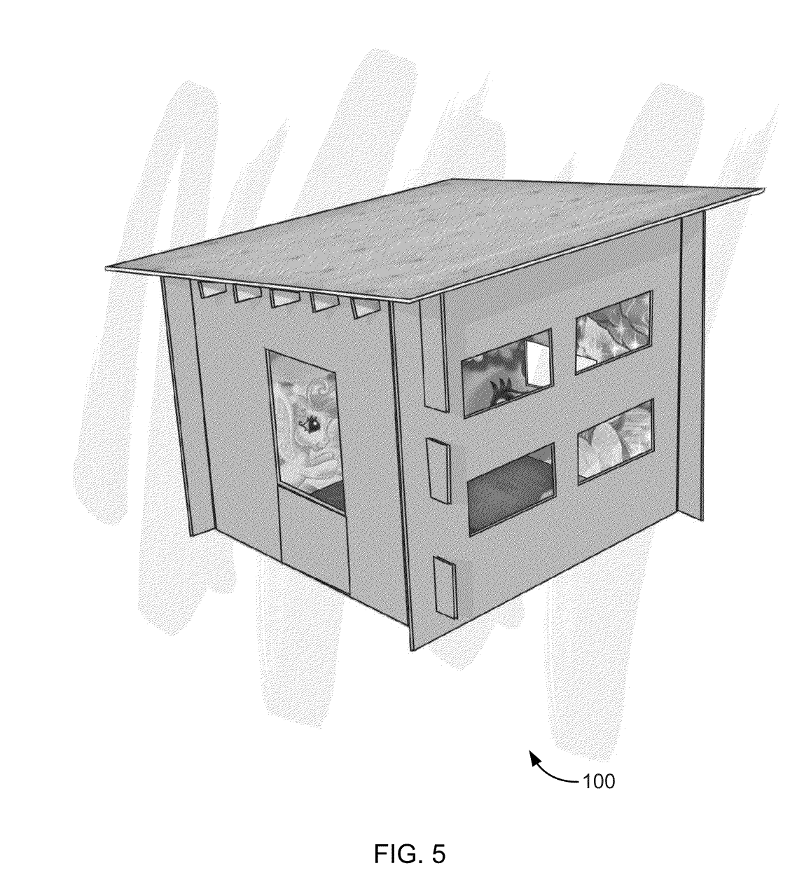

FIG. 5 shows an embodiment having multiple windows on a wall of the three dimensional structure 100, an additional window on a second wall, a Dutch door (also known as a stable door or half-door), and a slanted roof. FIG. 5 also shows a fantasy pony theme printed on the interior walls.

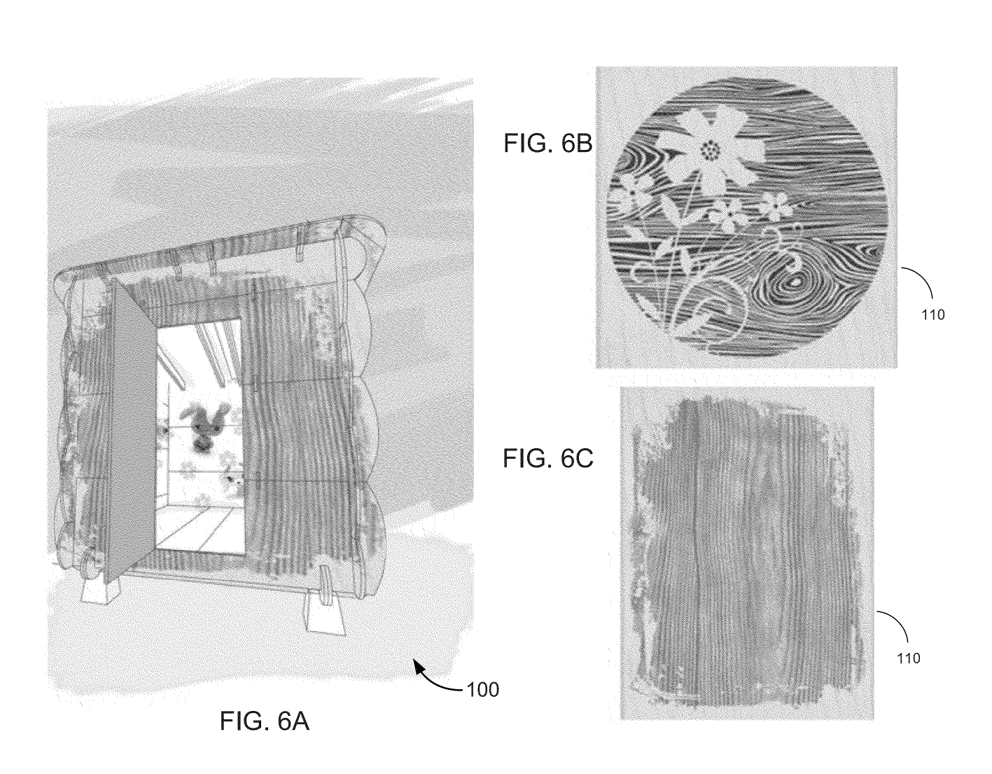

FIG. 6A is a front elevation view of an embodiment of the three dimensional structure 100 having a chalkboard surface on the interior of the door, roof beams, multiple panels for each wall interconnected by connectors, and stands on which the three dimensional structure 100 rests on the ground. FIG. 6A shows a wood theme pattern on the exterior surface of the three dimensional structure 100, with animal and floor theme patterns on the interior walls. FIGS. 6B and 6C show close-up views of the nature theme patterns, with FIG. 6B showing a flowing pattern overlaid on a wood pattern, while FIG. 6C shows a wood pattern.

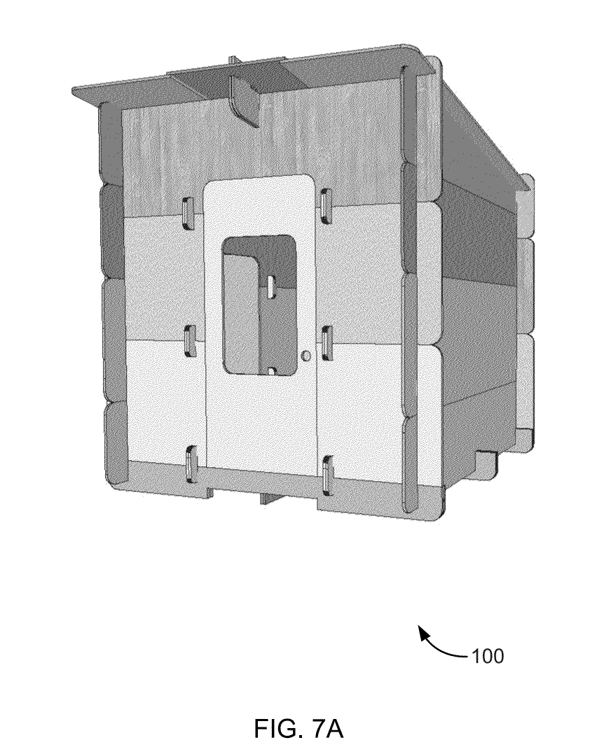

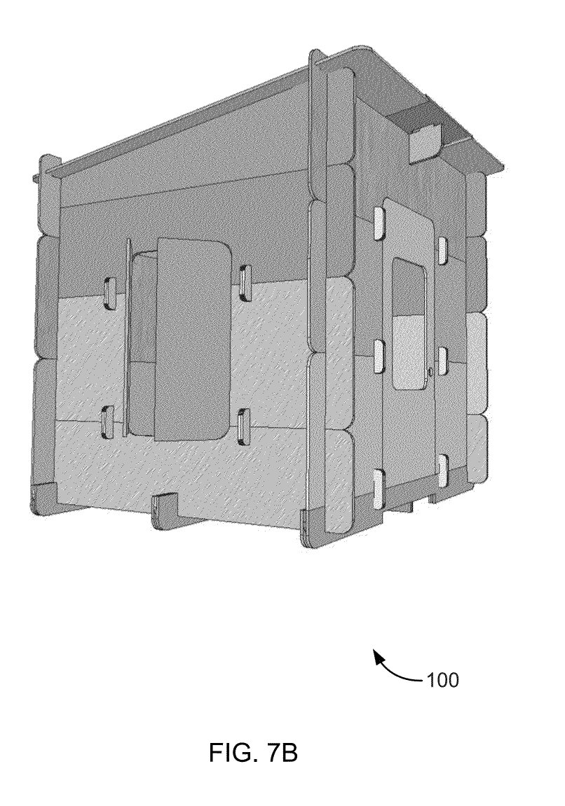

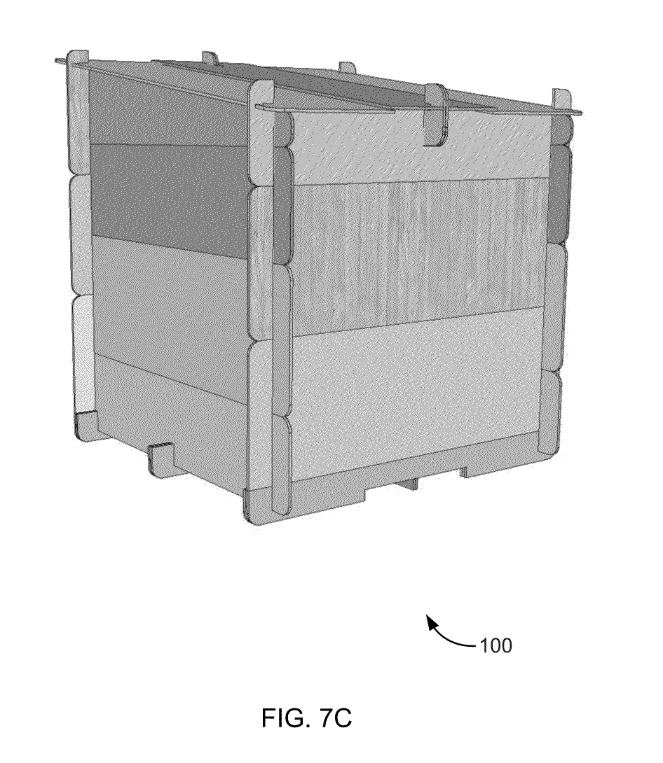

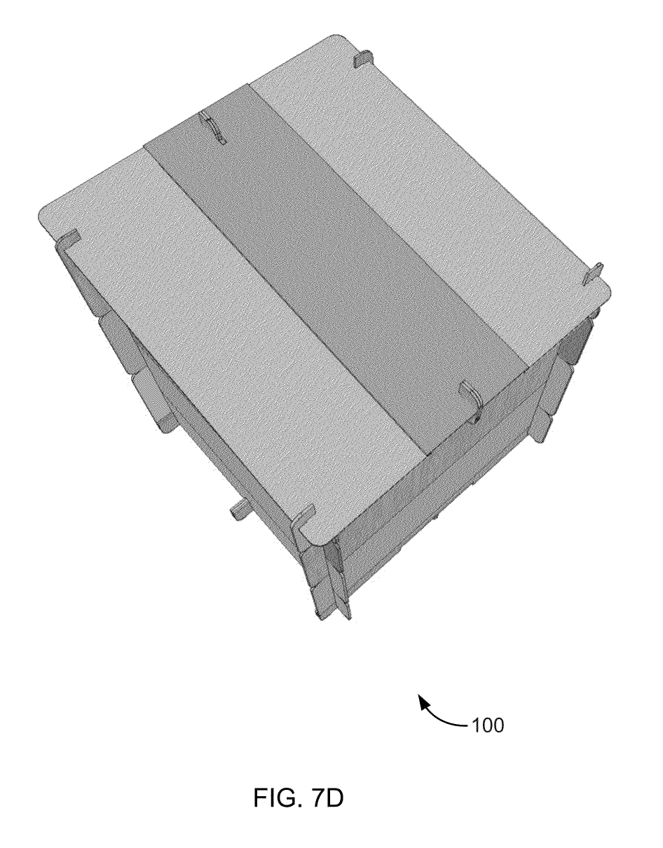

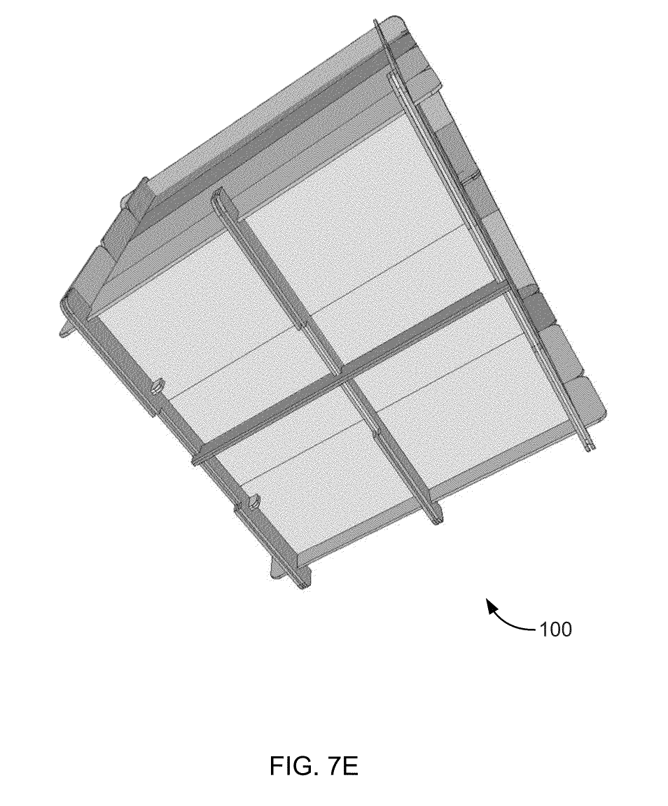

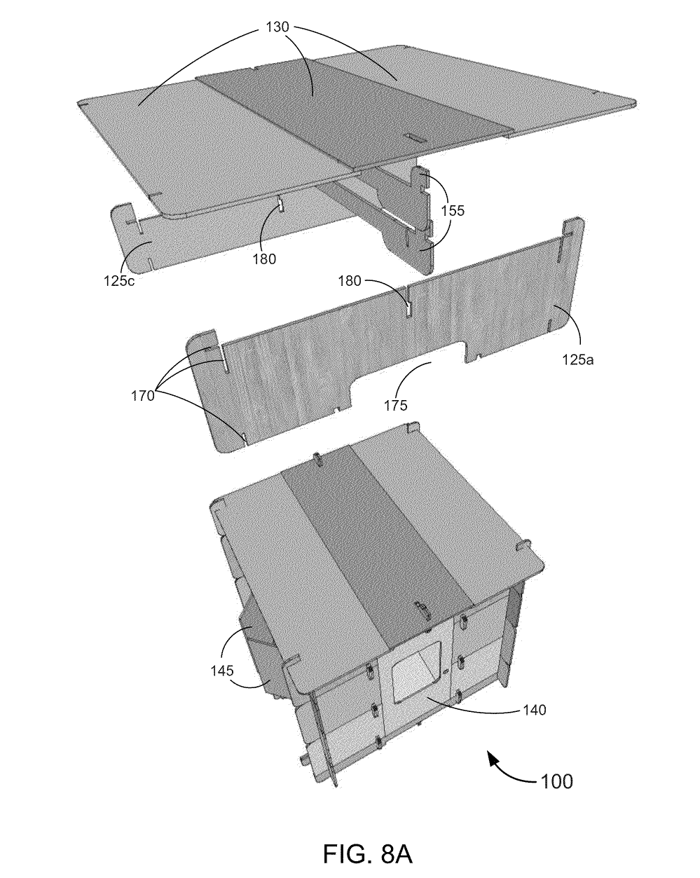

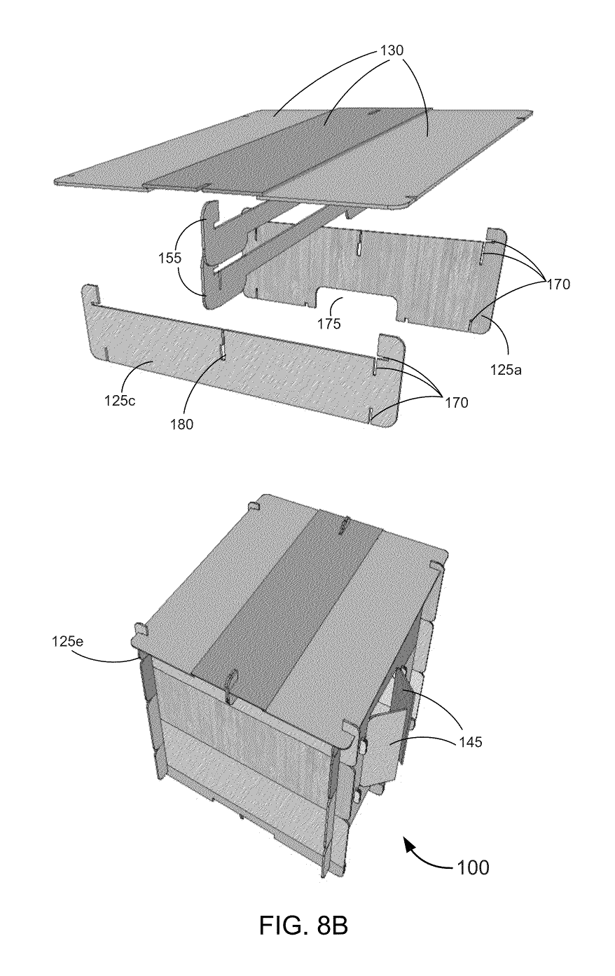

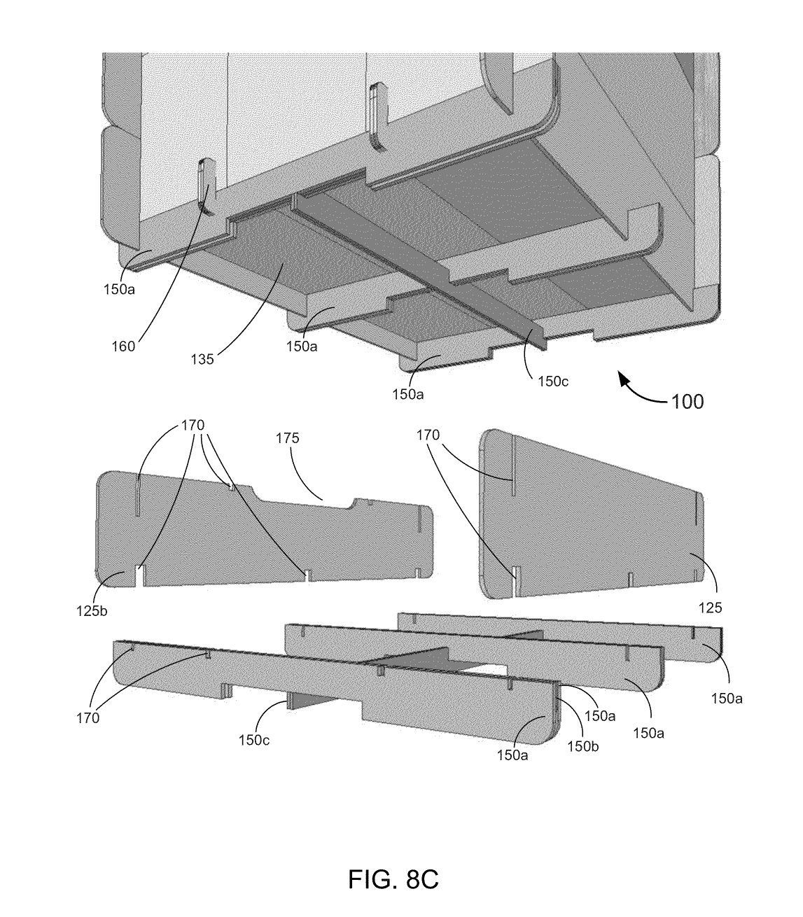

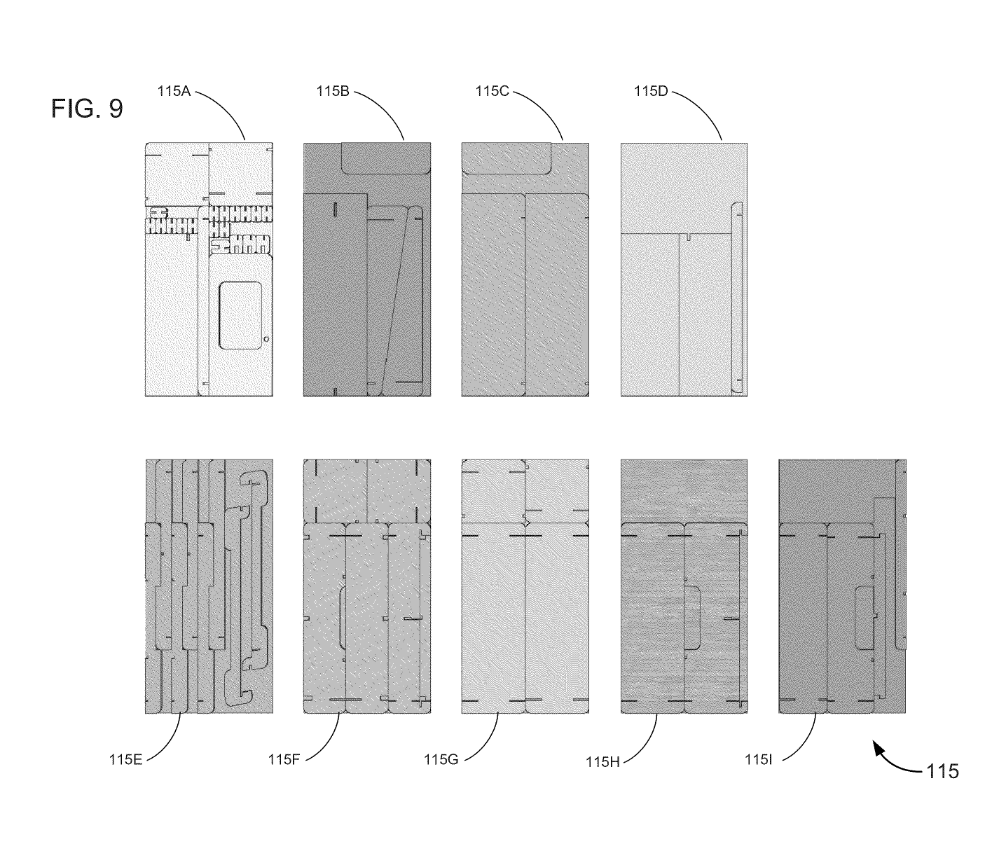

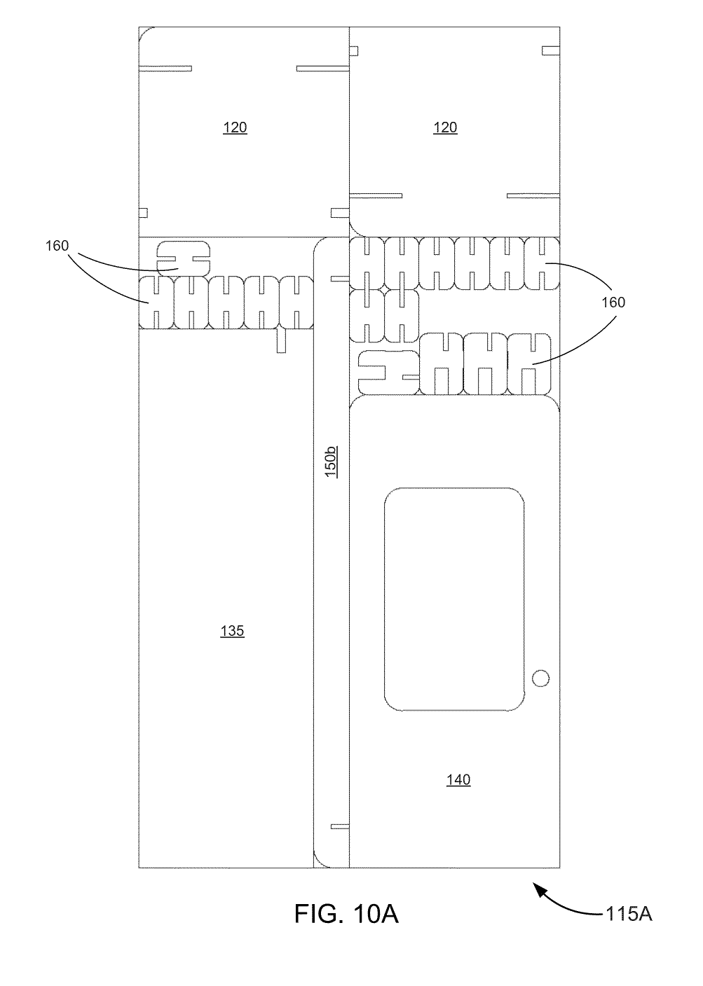

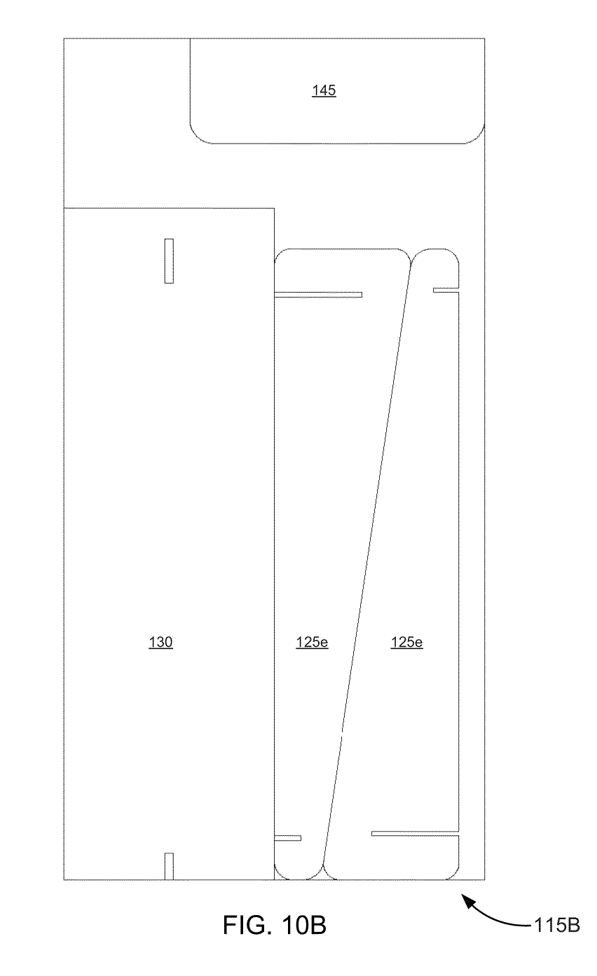

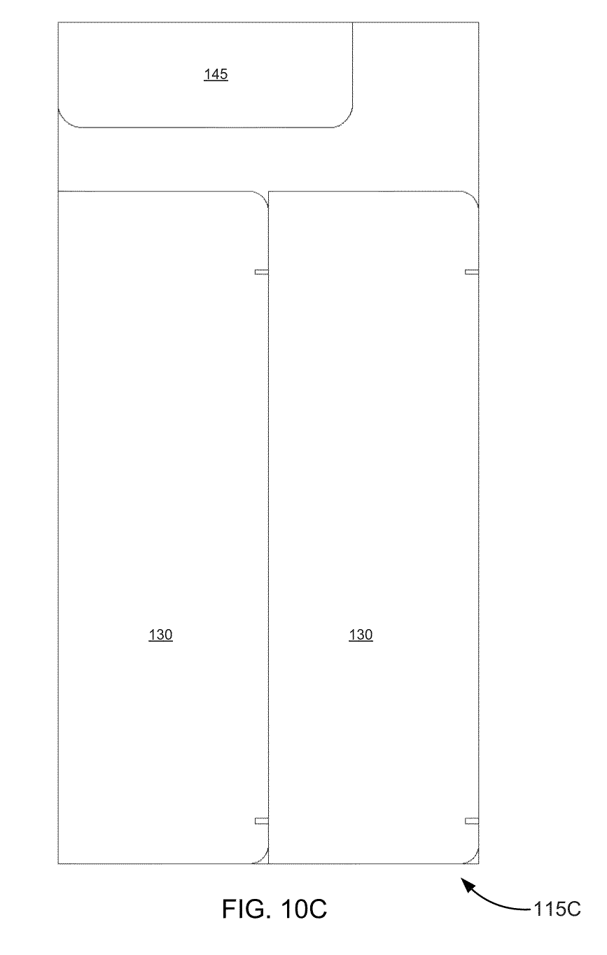

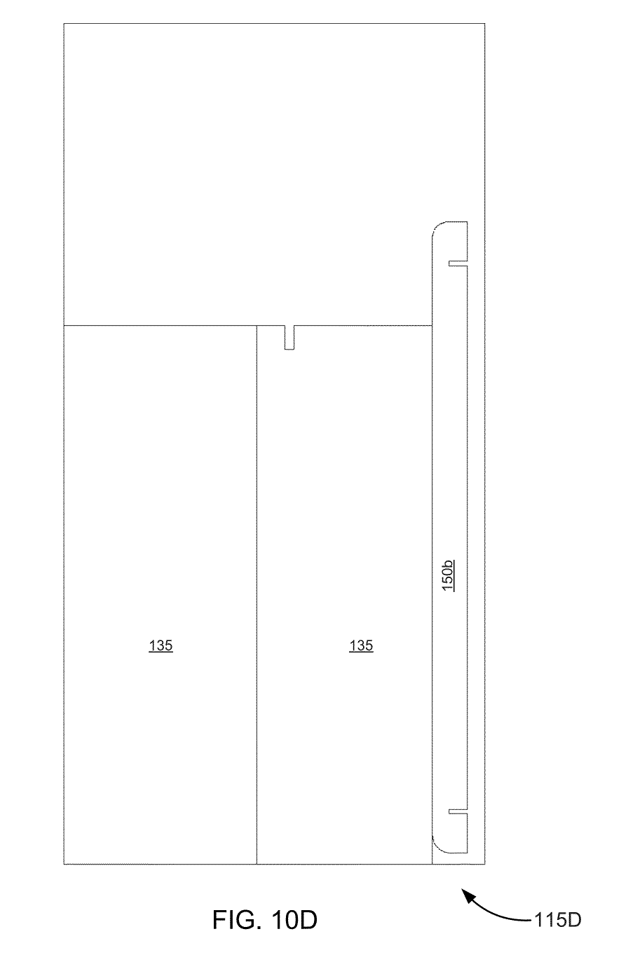

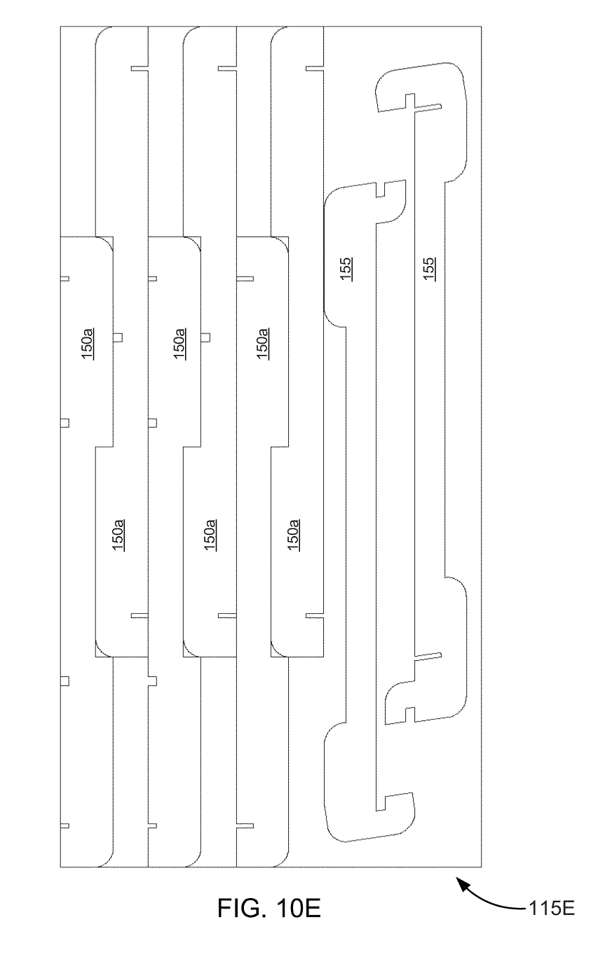

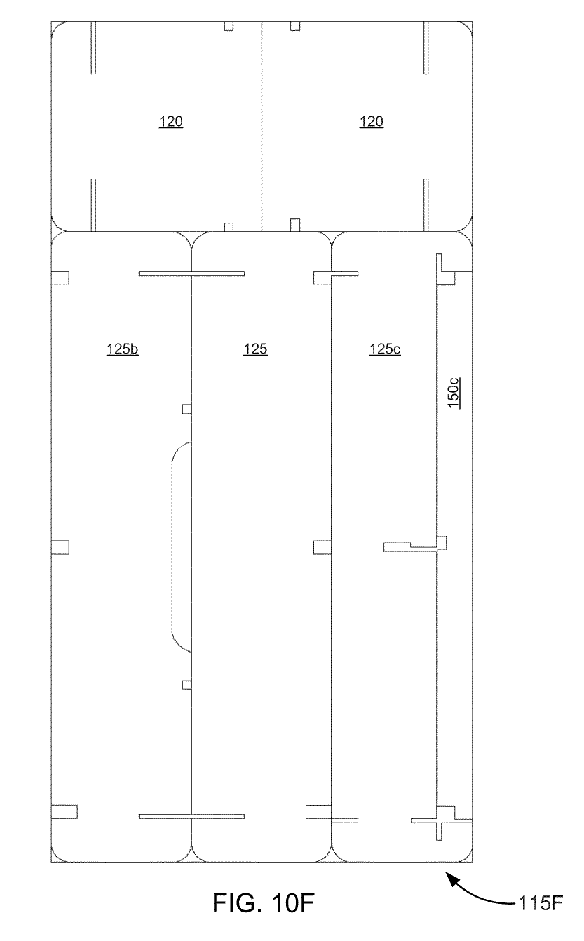

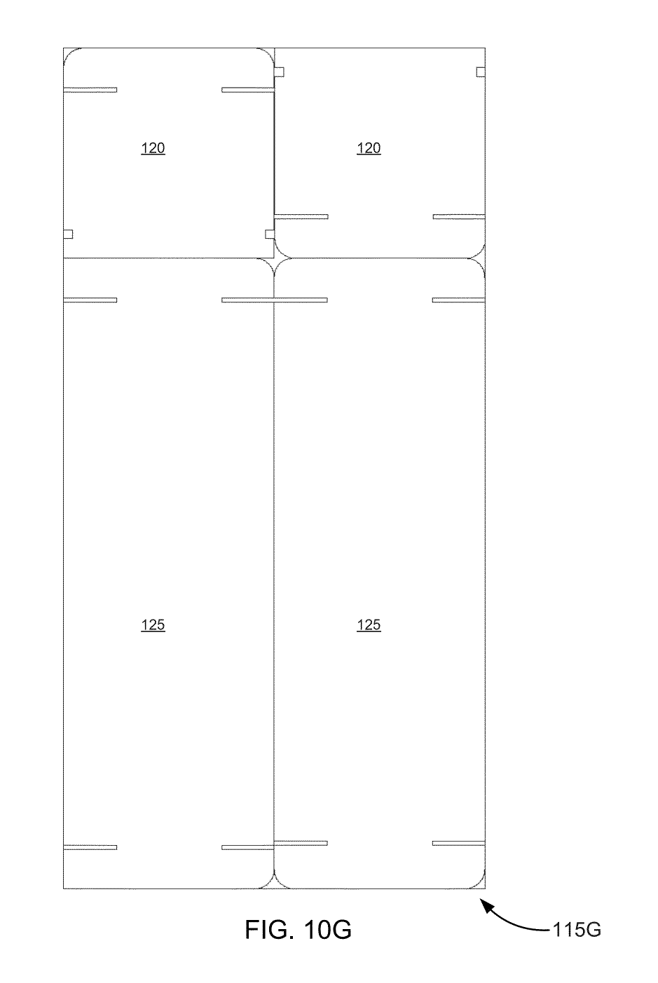

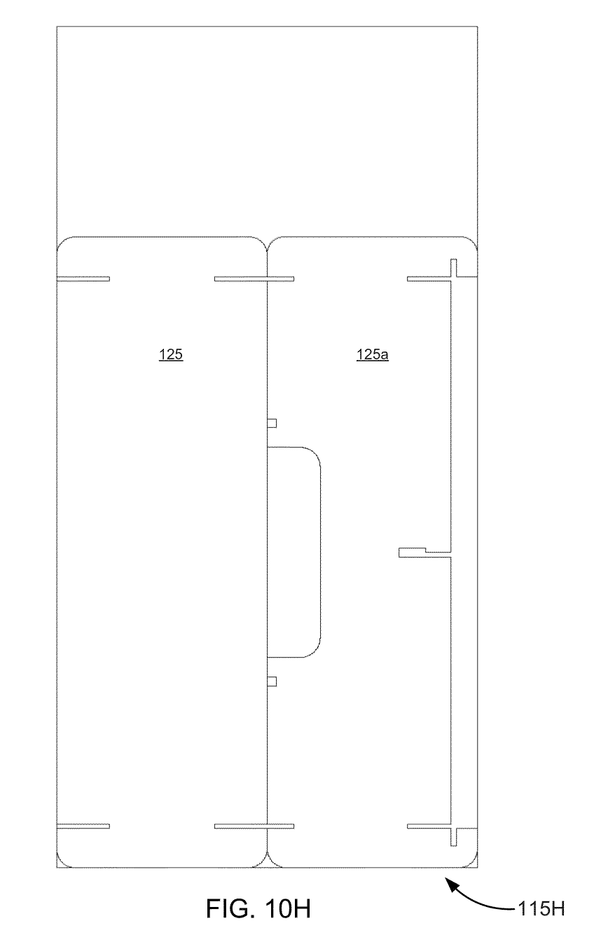

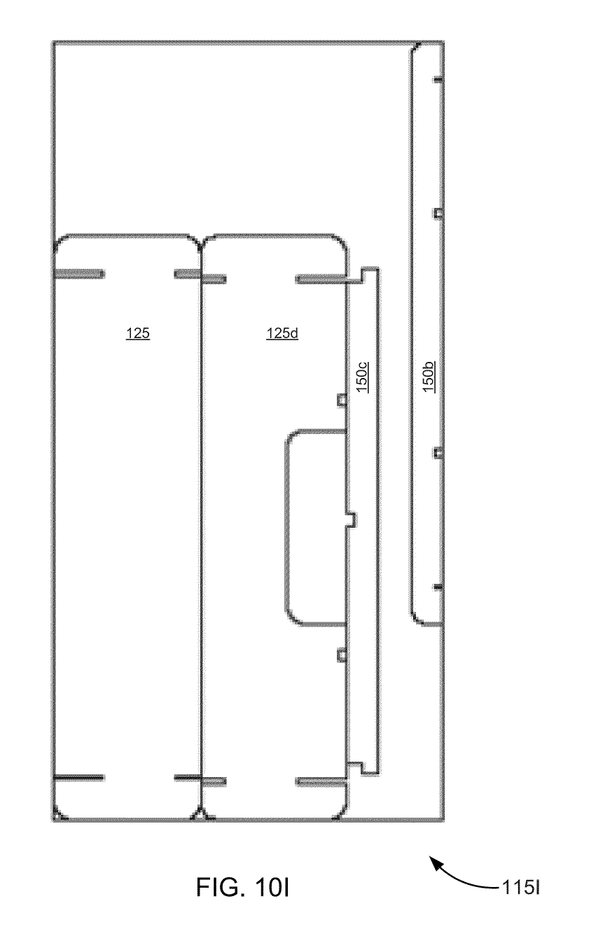

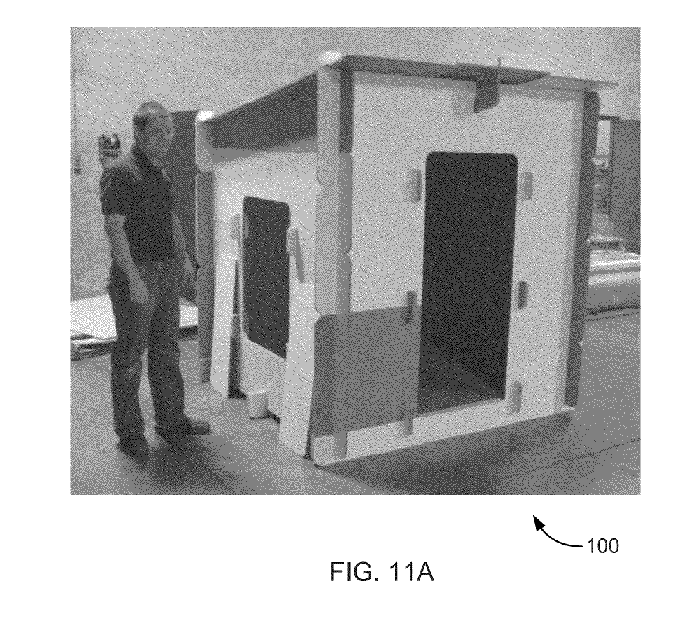

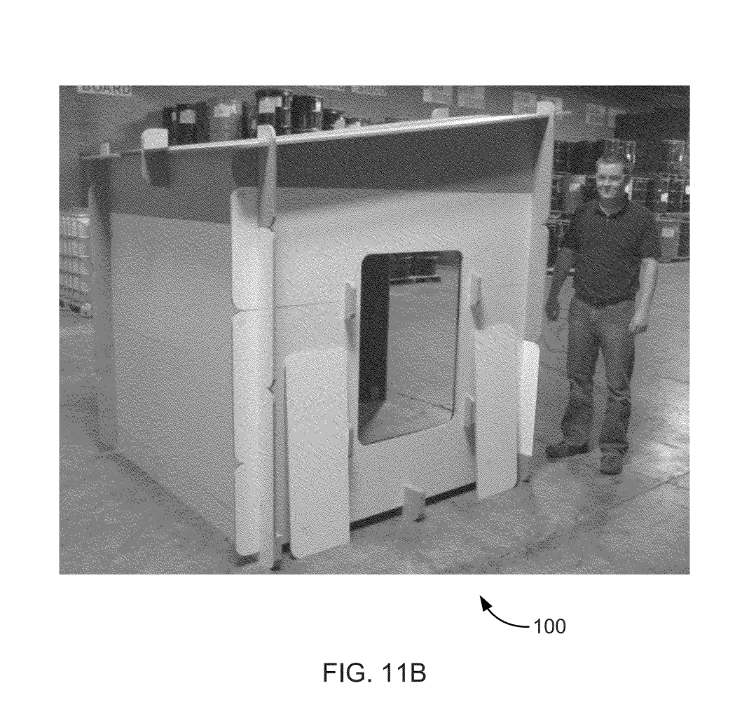

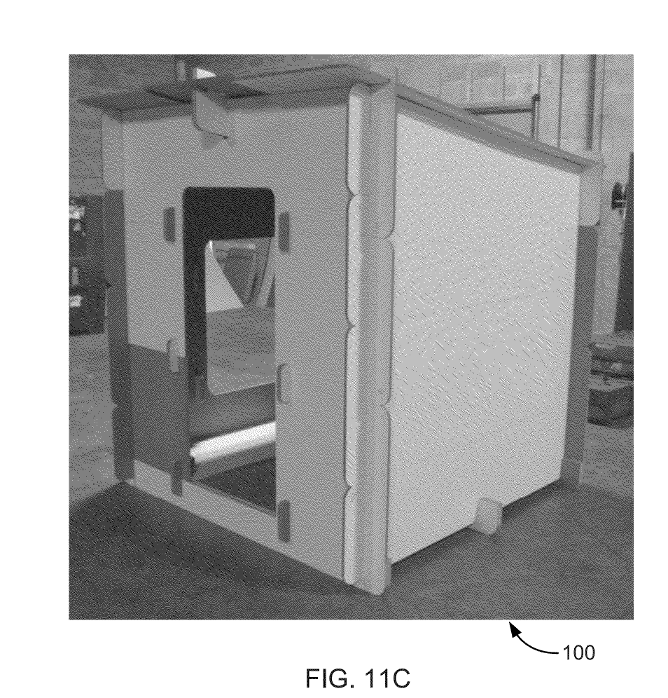

FIGS. 7A-8C show various views of one example of an embodiment of the three dimensional structure 100. FIGS. 9-10I shows a sheet of material cut-out schematic designs for the example three dimensional structure 100 as shown in FIGS. 7A-8C. The sheet of material can be made of any of a number of materials including plywood, particle board, plastic, metal, composites or the like suitable for providing sufficient structural integrity for the intended purpose and size of the three dimensional structure. While the panels are often referred to herein as being plywood panels, this should be viewed as merely an example of one likely material of choice and not limiting on the scope of the disclosure or the appended claims. The photographs of FIGS. 11A-11C illustrate the example of the three dimensional structure 100 as shown in FIGS. 7A-10I. The details of the example are discussed below in the Examples portion of this disclosure. Although the interlocking connectors as shown in FIGS. 7A-11C utilize “H-clips” that slip into slots 170 of the panels to hold the panels together, other forms of connectors may be utilized (e.g., snapping connectors, notch-hole connectors, etc.).

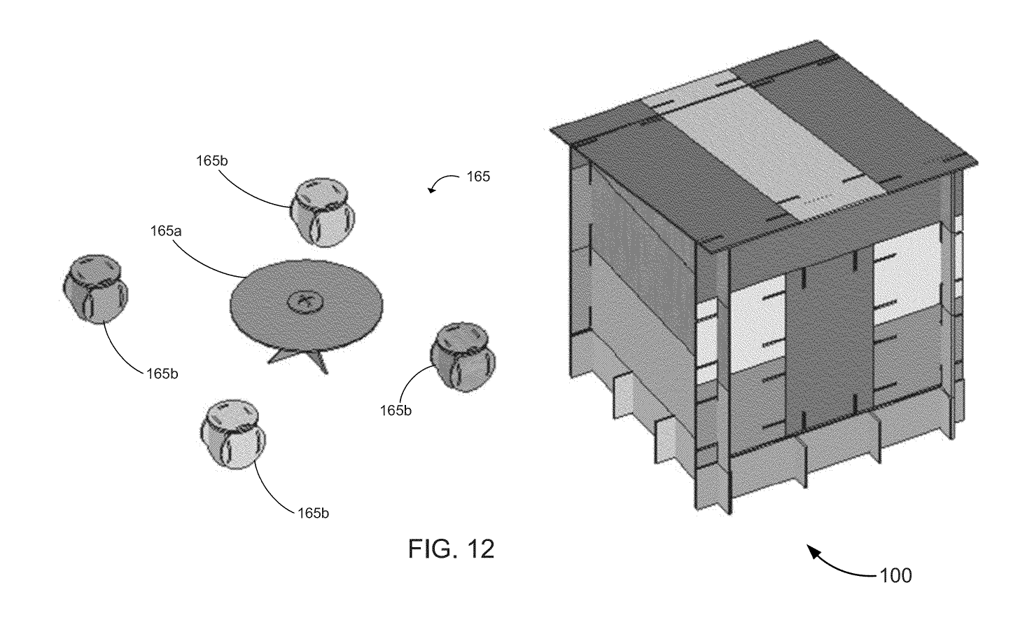

FIG. 12 shows an embodiment of the three dimensional structure 100, shown together with furniture 165, including a table 165a and a plurality of chairs 165b. The table 165a and the plurality of chairs 165b may be assembled in a tool-free manner from the same materials as the panels and components used to assemble the three dimensional structure 100. In some embodiments, the components for furniture 165 may be derived from portions of the sheet materials not utilized for the panels and components of the three dimensional structure 100. For example, as shown in FIGS. 9-10I, sheets such as 115B, 115C, 115D, 115H, and 115I have excess materials that could be used to produce the components for furniture 165. In particular, the large excess area in sheet 115D may be used to form the table surface for table 165a; the table surface may be circular as shown in FIG. 12, rectangular, or square, as desired).

Various embodiments may be implemented in any manner consistent with the description herein.

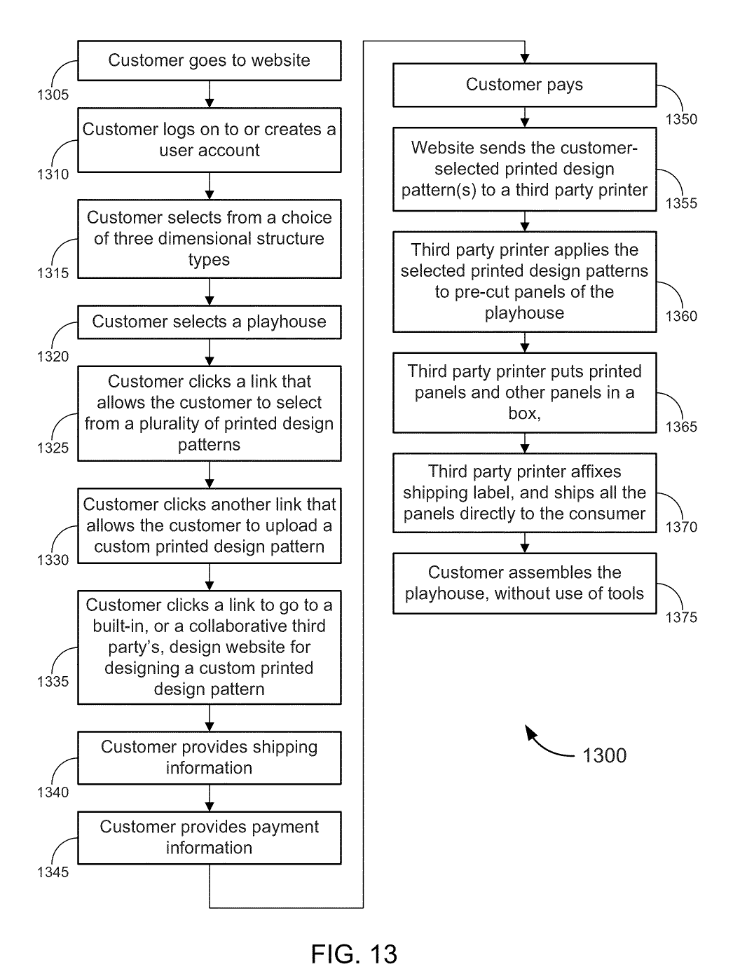

FIG. 13 is a flowchart showing one possible manner of implementing the method of selling a printable three dimensional structure 100. Some steps of FIG. 13 may be implemented in a different order. Some steps of FIG. 13 are optional. With reference to FIG. 13, a customer first utilizes a web browser to visit the website hosting the display and sale of the three dimensional structure 100 (e.g., amazon.com™ or other retail website) (Step 1305). Optionally, the customer may at this time, or prior to completing the order, log onto or create a user account (Step 1310). The customer then selects from a choice of three dimensional structure types, including (but not limited to) a playhouse, a dollhouse, a doghouse, (or a cathouse), office cubicle, retail displays, tradeshow displays and a storage shed (Step 1315). In this example, the customer selects a playhouse (Step 1320). Optionally the customer may made further selections such as material type, special surface treatments (e.g. weatherizing panels intended for outdoor use), surface texturing or the like.

The customer may then select what patterns to be printed on the panels of the playhouse. For example, the customer may click or follow a link that allows the customer to select from a plurality of printed design patterns (Step 1325); the webpage showing the design patterns may automatically load upon selection of the type of three dimensional structure. Alternatively, the customer may click or follow a link that allows the customer to upload a custom printed design pattern (Step 1330). In yet another alternative, the customer may click or follow a link to go to a built-in, or a affiliate third party's, design website for designing a custom printed pattern (Step 1335). Alternative to separate webpages for selection of the printed design pattern, the webpage displaying the playhouse could include a portion that displays a plurality of thumbnails each showing a playhouse having a particular printed design pattern. Scrolling over each thumbnail could trigger an enlargement of the particular playhouse with the particular printed design pattern. The design patterns would include those as described above with respect to FIGS. 1-6.

In Steps 1340 and 1345, the customer provides the shipping and payment information. The customer then confirms the order, thus paying for the three dimensional structure (Step 1350).

Upon completion of the order in Step 1350, the customer-selected printed design pattern(s) is sent to a third party printer (Step 1355). The third party printer applies (by printing) the selected printed design patterns to already pre-cut panels of the playhouse (Step 1360). The third party printer then packages the printed panels and other panels and components in a box, to form a playhouse kit (Step 1365). The third party printer subsequently affixes on the box a shipping label corresponding to the shipping information provided by the customer in Step 1340, and ships the box or playhouse kit directly to the customer (Step 1370). The customer, upon receiving the box or playhouse kit, assembles the playhouse without the use of tools (Step 1375). As an optional step, because the three dimensional structure 100 is easy to assemble and disassemble without the use of tools, the printed panels may be returned to the third party printer for reprinting, following a repeat of Steps 1305, 1310, and 1325-1355. Once the third party printer receives the printed panels (or the whole playhouse) from the customer, the printed panels would be painted white, and Steps 1355-1375 would be repeated. The reprinting may be to maintain faded printed patterns, to reprint drawn-over printed patterns, or to update the design patterns as the child grows older (and his/her preferences change). While reprinting could be by disassembling and returning the panels, other alternatives include ordering from the supplier replacement panels, adhesive stickers printed with new images to cover existing panels or sheets (made of vinyl or suitable materials) printed with images that can be placed over the existing surfaces such as panels, walls or the floor.

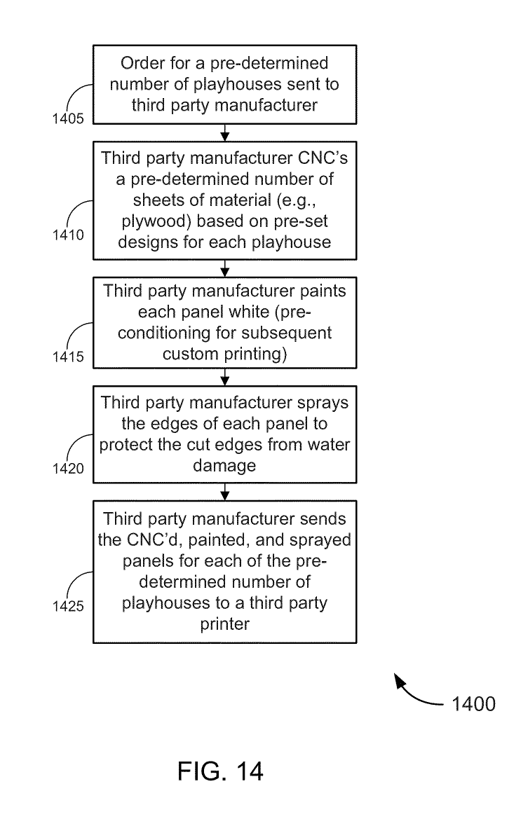

FIG. 14 is a flowchart showing one possible manner of implementing the method of manufacturing the panels and components for a printable three dimensional structure 100. Some steps of FIG. 14 may be implemented in a different order. Some steps of FIG. 14 are optional. With reference to FIG. 14, an order for panels and components for a set number (e.g., 100) playhouses is sent to a third party manufacturer (Step 1405). Likewise a set number of other types of three dimensional structures (e.g., a playhouse, a dollhouse, a doghouse, a cathouse, or a storage shed, etc.) may also be sent to the manufacturer. The third party manufacturer, through a process called computerized numerical control (CNC), can produce or cut a pre-determined number of sheets of material—including (but not limited to) wood, plywood, sheet metal, plastic sheets, and combinations thereof—based on pre-set designs for each playhouse (Step 1410). For simplicity with respect to the flowcharts and steps in FIGS. 13 and 14, the playhouse design is a pre-set design comprising a pre-set number of panels and components that follow the schematic diagrams as shown, e.g., in FIGS. 9-10I. Embodiments of the three dimensional structure 100 are not limited to a single pre-set design; the three dimensional structure 100 may include a variety of pre-set or customizable designs having, e.g., various sizes of the structure, multiple rooms, single or multiple windows located on wall panel(s) in a customizable or pre-set manner, single or multiple doors of various kinds (e.g., chalkboard, large, small, rectangular, curved, Dutch, etc.) located on wall panel(s) in a customizable or pre-set manner, customizable or pre-set roofs or floors, etc.

The third party manufacturer, after producing or cutting the panels and components for each playhouse, paints each panel white as a pre-conditioning step for subsequent printing of the patterns by the third party printer as described in relation to Step 1360 (Step 1415). The third party manufacturer also sprays the edges of each panel to protect the cut edges from water damage (Step 1420). Optionally, the third party manufacturer may sand or file down the cut edges to eliminate any splinters or rough edges that could be hazardous to children or animals. Another optional step may be for the third party manufacturer to apply a marker on each panel and component for aiding the customer in assembling the playhouse. The marker may be applied on any surface that would not later be printed over by the third party printer; as a non-limiting example, the marker may be applied on an edge of a panel that may subsequently abut another panel during assembly of the playhouse. The marker may preferably be a permanent marking, including (but not limited to) a painted decal with alphanumeric symbols that may be stapled or nailed to the panel (e.g., an edge of the panel), an engraved nail having alphanumeric symbols, and simply alphanumeric symbols painted onto the panel (e.g., an edge of the panel). The alphanumeric symbols or markings in general would corresponding to alphanumeric symbols or markings in an assembly guide to be included in the box or playhouse kit to be shipped to the customer, as described above in Steps 1365 and 1370. The markings may also be used to mark each panel and component for any other type of three dimensional structure (e.g., a playhouse, a dollhouse, a doghouse, a cathouse, cubicle, retail or tradeshow display or a storage shed, etc.) in a similar manner as discussed above with respect to marking for a playhouse.

In Step 1425, the third party manufacturer would subsequently send the cut, painted, and sprayed panels for each of the pre-determined number of playhouses (e.g., 100) to a third party printer. This allows the third party printer to stockpile a number of sets of playhouses so that when an order from a customer is transmitted to the third party printer as described in Step 1355, the third party printer may immediately thereafter print the customer-selected design pattern on the panels and send the printed playhouse kit to the customer with a minimal turn-around time.

For attachment of the door panel 140 and the window panels 145, conventional attachment implements may be utilized (including, but not limited to, hinged structures, spring-activated hinged structures, etc.). In some embodiments the attachment implements are to be configured to fasten to the panels without the use of tools.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

### EXAMPLES

The following example is provided for illustrative purposes only and is not intended to limit the scope of the invention.

### Example 1

With reference to FIGS. 7A-11C, a three dimensional structure 100 was created to illustrate one embodiment (in this case, a roughly 6′×6′×6′ (or ˜1.83×1.83×1.83 m) printable playhouse structure).

FIGS. 11A-11C shows the three dimensional structure 100 that was made to scale based on a modified version of the designs as shown in FIGS. 7A-10I.

FIGS. 9-10I show plywood sheets with cut-out designs for the panels and components for the three dimensional structure 100. Sheet 115A includes cut-outs for the door 140, one floor panel 135, a floor beam support structure 150b, two square front wall panels 120, and the H-clips 160 (which include 14 small H-clips and 4 large H-clips). Sheet 115B includes one window panel 145, the middle roof panel 130, and two roughly triangular side panels 125e (that are designed to make the roof slanted with respect to the ground or floor panels). Sheet 115C includes the other window panel 145, and the two remaining roof panels 130. Sheet 115D includes two floor panels 135 and one floor beam support structure 150b. Sheet 115E includes six floor beam structures 150a (two of which would sandwich one floor beam support structure 150b to provide for added strength of the overall floor beam structure), and two roof beam structures 155. Sheet 115F includes two square side wall panels 120, one side wall panel 125b with partial window recess 175, one regular side wall panel 125, one back wall panel 125c with roof panel slot 180, and one longitudinal floor beam 150c. Sheet 115G includes two square front wall panels 120, one side wall panel 125, and one back wall panel 125. Sheet 115H includes one back wall panel 125 and one front wall panel 125a which includes a partial window recess 175 and a roof panel slot 180. Sheet 115I includes one side wall panel 125d with partial window recess 175, one regular side wall panel 125, one longitudinal floor beam 150c, and one floor beam support structure 150b. FIG. 9 is color-coded to match the color-codes in FIGS. 7A-8C.

With reference to FIGS. 7A-7E and FIGS. 10A-10I, slots 170 on the square front panels 120 and on the front panel 125a allow H-clips 160 and side wall panels 125, 125a, 125d, and 125e to interconnect in a tool-free manner with the square front panels 120 and with the front panel 125a. Likewise, the slots 170 on the back wall panels 125, 125c allow side wall panels 125, 125a, 125d, and 125e to interconnect in a tool-free manner with the back wall panels 125, 125c.

With reference to FIGS. 8A-8B, slots 170 on front wall panel 125a and back wall panel 125c allow roof panels with corresponding slots to interconnect in a tool-free manner with front wall panel 125a and back wall panel 125c. Slot 180 on each of front wall panel 125a and back wall panel 125c allow roof beams 155 to interconnect in a tool-free manner with the front wall panel 125a and back wall panel 125c. The slots 180 have a relatively narrow inlet having a width corresponding to the width of a roof beam and wider cavity located at the bottom of the narrow inlet, the wider cavity having a width corresponding to the width of two roof beams, with the cavity being offset by one roof beam width from the inlet. In other words, the cavity extends by one roof beam width in a direction substantially perpendicular to the length of the inlet. The use of two roof beams 155 locks one roof beam within the cavity to secure the roof beams against upward wind loads, thus allowing for added strength as well as to prevent lateral movement within the slot 180. The slots on roof beams 155 allow for tool-free interconnection with middle roof panel 130, which has corresponding slots therein. The slots on the roof beam engaging the roof panel secure the roof panels against upward forces and cooperate with the action of gravity to maintain the roof panels in place. The roof panels are installed in an order that makes them self-locking. In the illustrated example, the two side roof panels are first installed followed by the middle roof panel that serves to hold the side panels in place.

With reference to FIG. 8C, each of the three floor beam support structures 150b is sandwiched by two floor beam structures 150a to form a combined floor beam. The three combined floor beams are held apart at pre-determined distances by two longitudinal floor beams 150c with a slot in the middle of the longitudinal floor beams 150c corresponding to slots in the middle of the center combined floor beam and grooves on either end of the longitudinal floor beams 150c corresponding to slots or grooves in the middle of each of the other two combined floor beams; two are used to increase strength of the floor support, similar to the use of two roof beams 155, as discussed above. Slots 170 in side wall panels 125 allow the combined floor beams to interconnect in a tool-free manner with the side wall panels 125.

The description has been presented for purposes of illustration and description, but is not intended to be exhaustive or limiting of the invention to the form disclosed. The scope is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

1. A three dimensional structure, comprising:
at least three interlocking panels;
wherein the at least three interlocking panels are configured so as to interlock one with at least one other without the use of hand tools.

2. The three dimensional structure of claim 1, wherein the at least three interlocking panels have an interior surface and an exterior surface, wherein at least one of the interior surface and the exterior surface of one or more of the at least three interlocking panels has a first printed pattern applied thereon.

3. The three dimensional structure of claim 2, further comprising:
at least four interlocking wall panels;
at least one roof panel;
wherein the at least one roof panel is configured so as to interlock with one or more of the at least four interlocking wall panels, without the use of hand tools.

4. The three dimensional structure of claim 3, further comprising at least one floor panel configured to be connectable, in a tool-free manner, with one or more of the at least four interlocking wall panels.

5. (canceled)

6. The three dimensional structure of claim 2, wherein the first printed pattern is selectable from at least one of a plurality of pre-designed patterns and at least one custom design pattern.

7. The three dimensional structure of claim 6, wherein the at least one custom design pattern is designed by a customer or designed on behalf of the customer.

8. The three dimensional structure of claim 6, wherein the at least one of the plurality of pre-designed patterns and at least one custom design pattern are selectable from a group consisting of bright color patterns, dark color patterns, multicolor patterns, character patterns, nature patterns, abstract patterns, and any combination thereof, wherein the character patterns include patterns resembling animals, patterns resembling humans, patterns resembling man-made structures, and patterns resembling fictional animal, human, or non-terrestrial characters, wherein the nature patterns include patterns resembling plant life, patterns resembling nature scenes, and patterns resembling fictional terrestrial or non-terrestrial landscapes.

9. The three dimensional structure of claim 4, wherein each of two or more of the at least four interlocking wall panels, the at least one roof panel, and the at least one floor panel includes at least one slot therein, wherein each of said at least one slot is configured to interlock with another of said at least one slot so as to connect, in a tool-free manner, two of the at least four interlocking wall panels, the at least one roof panel, and the at least one floor panel.

10. The three dimensional structure of claim 4, further comprising at least one support module on which one or more of the at least one floor panel and the at least four interlocking wall panels rests on a surface of the ground.

11. The three dimensional structure of claim 3, further comprising a plurality of connectors,
wherein the at least four interlocking wall panels are configured to connect with each other and with the at least one roof panel via use of the plurality of connectors, and
wherein the plurality of connectors are configured to connect the at least four interlocking wall panels and the at least one roof panel to each other without use of hand tools.

12-13. (canceled)

14. The three dimensional structure of claim 3, wherein the at least four interlocking wall panels are of different dimensions, such as to form a three dimensional structure of irregular shape, when the at least four interlocking wall panels are assembled together with the at least one roof panel.

15-16. (canceled)

17. A method of manufacturing a three dimensional structure, the method comprising:
forming at least three interlocking panels, wherein each of the at least three interlocking panels includes a first surface and a second surface, wherein the first surface is designated to be an interior surface when the three dimensional structure is assembled, and wherein the second surface is designated to be an exterior surface when the three dimensional structure is assembled;
tooling one or more of the at least three interlocking panels so as to make one interlockable with at least one other in a tool-free manner; and
applying a printed pattern on at least one surface of one or more of the at least three interlocking panels.

18. The method of claim 17, further comprising forming four wall panels and at least one roof panel, wherein the at least one roof panel is configured so as to interlock with one or more of the at least four interlocking wall panels, without the use of hand tools.

19. The method of claim 18, further comprising forming at least one floor panel.

20. The method of claim 19, wherein forming the at least four wall panels, the at least one roof panel, and the at least one floor panel includes forming the panels by cutting from one or more pieces of material, wherein the one or more pieces of material are selected from a group consisting of planks of wood, planks of plywood, sheet metal, plastic sheets and combinations thereof.

21. (canceled)

22. The method of claim 19, wherein tooling the one or more of the at least four wall panels and the at least one roof panel includes forming at least one slot in each of two or more of the at least four interlocking wall panels, the at least one roof panel, and the at least one floor panel.

23. The method of claim 19, wherein tooling the one or more of the at least four wall panels and the at least one roof panel includes forming a plurality of connecting points in each of two or more of the at least four interlocking wall panels, the at least one roof panel, and the at least one floor panel, wherein the plurality of connecting points are configured to connect with a plurality of connectors that allow the at least four interlocking wall panels to connect in a tool-free manner with each other and with the at least one roof panel.

24. The method of claim 18, further comprising:
forming at least one recess in one or more of the at least four wall panels;
forming at least one of a door panel and a window panel for each of the at least one recess; and
tooling the at least one of the door panel and the window panel so as to make the at least one of the door panel and the window panel interlockable with said one or more of the at least four wall panels in a tool-free manner.

25-26. (canceled)

27. The method of claim 18, wherein forming the at least four wall panels and the at least one roof panel includes forming the at least four wall panels having different dimensions, such as to form a three dimensional structure of irregular shape, when the at least four interlocking wall panels are assembled together with the at least one roof panel.

28. The method of claim 17, wherein applying the printed pattern on at least one surface of one or more of the at least three interlocking panels includes:
receiving a design pattern from a customer; and applying the received design pattern on at least one surface of one or more of the at least three interlocking panels.

29-50. (canceled)
